(19) United States
(12) Patent Application Publication
(10) Pub. No.: US 2005/0073534 A1
(43) Pub. Date: Apr. 7, 2005

(54) Mobile multimedia poster board

(76) Inventors: Hsi-Che Lee, Taipei (TW); Tung-Hsing Pan, Taipei (TW); Mei-Jiuan Chen, Taipei (TW)

Correspondence Address: RABIN & BERDO, P.C., Suite 500, 1101 14th Street, N.W., Washington, DC, 20005, US

(21) Appl. No.: 10/689,849

(22) Filed: Oct. 22, 2003

(30) Foreign Application Priority Data
Nov. 1, 2002 (TW) 091217569

(51) Int. Cl. G09G 3/36

(52) U.S. Cl. 345/905; 345/87

(57) ABSTRACT

A mobile multimedia poster board includes a box with a liquid crystal display on front side as well as a plurality of wheels on the bottom side thereof. The liquid crystal display is connected to a computer installed on some other place. In accordance with the structure mentioned above, the box is put on the ground for displaying animated advertisement run by multimedia program inside the computer.

### BACKGROUND OF THE INVENTION

1. Field of the Invention

The present invention relates to a mobile multimedia poster board, especially to a kind of poster board that includes a liquid crystal display arranged on the front side of a box and connected to a computer so as to display animated advertisement.

2. Description of the Prior Art

A traditional poster board used by a street vendor or stands is a standing transparent box with lateral side in isosceles triangle shape and light tubes inside for attracting consumers. On the front and rear side of the box is a price list.

If the price list needs to be modified, it is not convenient to make change, can only be modified by Permanent marker or sticker for temporary use. After a period of time, the words are getting blurred. A better way is to make a new poster board. However, it's not economic to make a new poster board just for a small part of modification.

Moreover, on the shops in the department, once there is a cut-price good or best buy products, the price list of such kind of products is painted on a pasteboard for sales promotion.

However, the price list written on the pasteboard is too flat and sloppy so that there is a need to improve the poster board.

### SUMMARY OF THE INVENTION

Therefore, it is a primary object of the present invention to provide a poster board having a box with a liquid crystal display disposed on the front side of the box and connected to a computer for running the program and displaying the advertisement on the liquid crystal display.

### BRIEF DESCRIPTION OF THE DRAWINGS

The accomplishment of the above-mentioned object of the present invention will become apparent from the following description and its accompanying drawings which disclose illustrative an embodiment of the present invention, and are as follows:

FIG. 1 is a perspective view of the present invention;

FIG. 2 is a cross-sectional view of the assembling of the present invention;

FIG. 3 is a cross-sectional view of the assembling of a further embodiment of the present invention.

### DETAILED DESCRIPTION OF THE PREFERRED EMBODIMENT

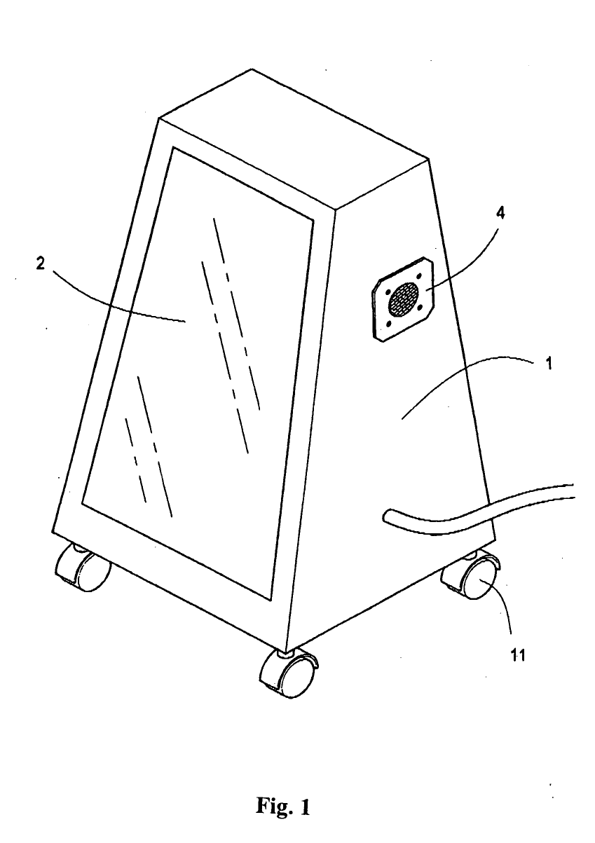

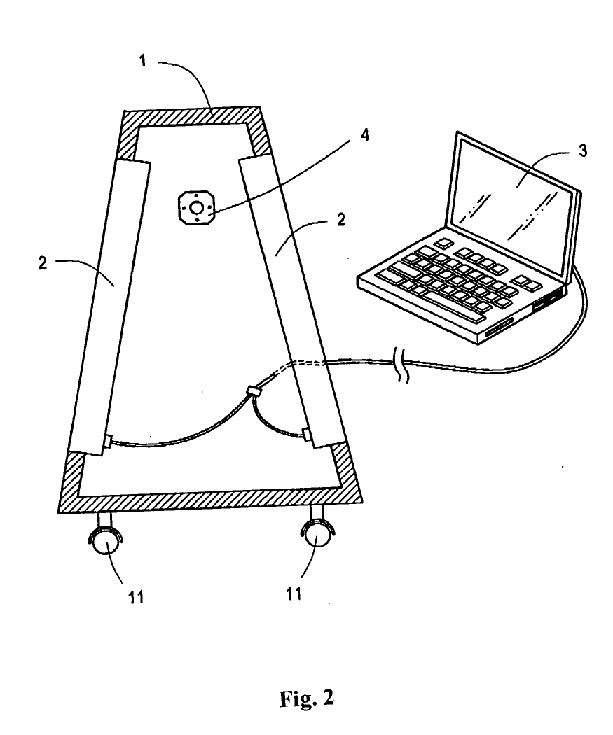

Refer to FIG. 1 & FIG. 2, the present invention includes a box 1 and a liquid crystal display 2;

the box 1 having a plurality of wheels 11 arranged on the four corners on the bottom side thereof for being moved freely;

the liquid crystal display 2 arranged on the front side of the box 1 and connected to a computer 3 disposed somewhere else for running multimedia program so as to display the animated advertisement on the liquid crystal display 2;

In accordance with the above-mentioned structure, the price list, product name and animated advertisement is preset in the computer 3 and then is displayed on the liquid crystal display 2 while the box 1 is moved to an opened place.

The price list and the advertisement is design by computer 3 so that it is easy to be modified and thus achieves better advertising effect.

Moreover, it is not necessary to make new poster board due to any modification so that there is any further cost for modifications.

Furthermore, the liquid crystal display 2 can also be disposed on the rear side of the box 1 so that both sides of the box 1 can display the advertisement. This is another embodiment of the present invention.

In addition, the liquid crystal display 2 can be replace with a plasma display panel (PDP). This is a further embodiment of the present invention.

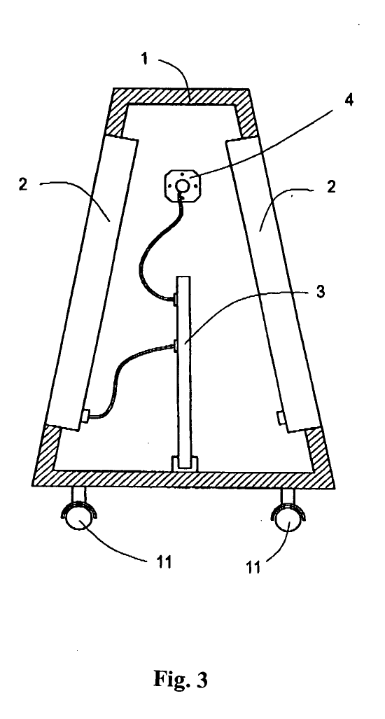

Refer to FIG. 3, the computer 3 can also be integrated inside the box 1. The keyboard and mouse (not shown in figure) can be connected later on some other place or hidden inside the box 1. This is a further embodiment of the present invention.

Refer to FIG. 1 & FIG. 2, a speaker 4 is arranged on each side of the laterals of the box 1 and is connected to the computer 3. If the multimedia program also has the voice function, the voice can also be displayed in accompany with the advertisement figures.

The advertisement shown on the liquid crystal display 2 is controlled by the multimedia program so that it can be designed and modified according to users' needs.

It should be noted that the above description and accompanying drawings are only used to illustrated some embodiments of the present invention, not intended to limit the scope thereof. Any modification of the embodiments should fall within the scope of the present invention.

1. A mobile multimedia poster board comprising
a box with a plurality of wheels for moving horizontally on the ground;
a liquid crystal display disposed on the front side of the box and connected to a computer arranged somewhere else for running multimedia program so as to make the animated advertisement displayed on the liquid crystal display.

2. The mobile multimedia poster board as claimed in claim 1, wherein said liquid crystal display can also be arranged on both front and read sides of the box.

3. The mobile multimedia poster board as claimed in claim 1, wherein said liquid crystal display can be replace with a plasma display panel.

4. The mobile multimedia poster board as claimed in claim 1, wherein said computer is arranged inside the box.

5. The mobile multimedia poster board as claimed in claim 1, wherein at least one speaker is installed on lateral sides of the box for displaying sounds and is connected to the computer.
